(19) United States
(12) Patent Application Publication
(10) Pub. No.: US 2019/0104473 A1
(43) Pub. Date: Apr. 4, 2019

(54) MANAGING DEVICE POWER ON SEQUENCES AND COMMUNICATIONS CONTROL FOR WIRELESS POWER TRANSFER

(71) Applicant: QUALCOMM Incorporaged, San Diego, CA (US)

(72) Inventors: Christopher Kong Yee CHUN, Austin, TX (US); Curtis GONG, San Diego, CA (US); Yung-Ho TSAI, San Diego, CA (US); Joseph MAALOUF, San Diego, CA (US); Sumukh SHEVDE, Carlsbad, CA (US); Anssi HAVERINEN, San Diego, CA (US); Abhijeet DHARMAPURIKAR, San Diego, CA (US); Chen NA, Cerritos, CA (US)

(21) Appl. No.: 15/782,530

(22) Filed: Oct. 12, 2017

Related U.S. Application Data
(60) Provisional application No. 62/565,968, filed on Sep. 29, 2017.

(51) Int. Cl. H04W 52/02; H04W 52/24

(52) U.S. Cl. CPC H04W 52/0235; H04L 27/0008; H04W 52/245

(57) ABSTRACT

The present disclosure describes aspects of managing communication control for wireless power transfer. In some aspects, a method for managing wireless charging communications is provided. The method includes wirelessly receiving power from a wireless power transmitter and providing the wirelessly received power to a power management circuit. The method further includes providing power and a power source indication signal to a transceiver circuit. The power source indication signal is indicating the power is the wirelessly received power. The method further includes performing an initialization sequence of the transceiver circuit in response to the power source indication signal, the initialization sequence including transmitting an advertisement message to the wireless power transmitter according to a wireless power communication profile for establishing the wireless communication session with the wireless power transmitter and initializing one or more other functions defined by the wireless power communication profile after transmitting the advertisement message.

### CLAIM OF PRIORITY UNDER 35 U.S.C. § 119

The present application for patent claims priority to Provisional Application No. 62/565,968 entitled “MANAGING DEVICE POWER ON SEQUENCES AND COMMUNICATIONS CONTROL FOR WIRELESS POWER TRANSFER” filed Sep. 29, 2017 and assigned to the assignee hereof and hereby expressly incorporated by reference herein in its entirety.

### FIELD

The present disclosure relates generally to wireless power transfer, and in particular to managing device power on sequences and communications control in conjunction with wireless power transfer.

### BACKGROUND

A variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power. As such, these devices constantly require recharging. Rechargeable devices are often charged via wired connections that require cables or other similar connectors that are physically connected to a power supply. Cables and similar connectors may sometimes be inconvenient or cumbersome and have other drawbacks. Wireless power charging systems, for example, may allow users to charge and/or power electronic devices without physical, electrical connections, thus reducing the number of components required for operation of the electronic devices and simplifying the use of the electronic device.

### SUMMARY

In some aspects an apparatus for controlling wireless charging communications is provided. The apparatus includes a wireless power receiver circuit configured to wirelessly receive power from a wireless power transmitter. The apparatus further includes a transceiver circuit operatively connected to the wireless power receiver circuit. The transceiver circuit is configured to wirelessly transmit and receive data. The transceiver circuit includes a transceiver controller and a transceiver memory. The transceiver memory is configured to store a set of instructions defining a wireless power communication profile for managing a wireless power charging session between the wireless power receiver circuit and the wireless power transmitter. The transceiver controller is configured to execute the set of instructions to cause the transceiver circuit to wirelessly transmit and receive data according to the wireless power communication profile. The wireless power receiver circuit is configured to provide power to the transceiver circuit in response to receiving power. The wireless power receiver circuit is further configured to, in response to receiving power, provide a power source signal to the transceiver circuit indicating that the power provided to the transceiver circuit is from the wireless power receiver circuit The transceiver controller is configured to, in response to receiving the power source signal, execute an initialization sequence. As at least a part of the initialization sequence the transceiver controller is configured to transmit an advertisement message to the wireless power transmitter according to the wireless power communication profile for establishing a wireless communication session with the wireless power transmitter. The transceiver controller is further configured to initialize one or more other functions defined by the wireless power communication profile after transmitting the advertisement message.

In another aspect, an apparatus for managing wireless charging communications is provided. The apparatus includes means for wirelessly receiving power from a wireless power transmitter. The apparatus further includes means for providing power and a power source indication signal to a transceiver circuit. The power source signal indicating that the power provided to the transceiver circuit is based on the wirelessly received power. The apparatus further includes means for performing an initialization sequence of the transceiver circuit in response to the power source indication signal. The initialization sequence includes transmitting an advertisement message to the wireless power transmitter according to a wireless power communication profile for establishing a wireless communication session with the wireless power transmitter. The initialization sequence further includes initializing one or more other functions defined by the wireless power communication profile.

In yet another aspect a method for managing wireless charging communications is provided. The method includes wirelessly receiving power from a wireless power transmitter. The method further includes providing power and a power source indication signal to a transceiver circuit, the power source indication signal indicating that the power provided to the transceiver circuit is based on the wirelessly received power. The method further includes performing an initialization sequence of the transceiver circuit in response to the power source indication signal. The initialization sequence includes transmitting an advertisement message to the wireless power transmitter according to a wireless power communication profile for establishing a wireless communication session with the wireless power transmitter. The initialization sequence further includes initializing one or more other functions defined by the wireless power communication profile after transmitting the advertisement message.

In yet another aspect, a non-transitory, processor-readable storage medium storing processor-readable instructions configured to cause a processor to execute a method for managing wireless charging communications is provided. The method includes wirelessly receiving power from a wireless power transmitter. The method further includes providing power and a power source indication signal to a transceiver circuit, the power source indication signal indicating that the power provided to the transceiver circuit is based on the wirelessly received power. The method further includes performing an initialization sequence of the transceiver circuit in response to the power source indication signal. The initialization sequence includes transmitting an advertisement message to the wireless power transmitter according to a wireless power communication profile for establishing a wireless communication session with the wireless power transmitter. The initialization sequence further includes initializing one or more other functions defined by the wireless power communication profile after transmitting the advertisement message.

### BRIEF DESCRIPTION OF THE DRAWINGS

In the figures, the left-most digit of a reference number identifies the figure in which the reference number first appears. The use of the same reference numbers in different instances in the description or the figures indicates like elements

FIG. 1 is a functional block diagram of an example implementation of a wireless power transfer system.

FIG. 2 is a functional block diagram of an example implementation of a device incorporating a wireless power receiver.

FIG. 3 is a functional block diagram of an exemplary more particular implementation of the device of FIG. 2.

FIG. 4 is a flow diagram of a method for controlling wireless power communications.

FIG. 5 is a flow diagram of a method for responding to power from a wireless power source.

### DETAILED DESCRIPTION

The detailed description set forth below in connection with the appended drawings is intended as a description of exemplary implementations and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations. In some instances, some devices are shown in block diagram form. Drawing elements that are common among the following figures may be identified using the same reference numerals.

Some wireless charging systems use a separate wireless communication protocol (e.g., Bluetooth/Bluetooth low energy (BLE)) in order to initiate and manage the wireless charging process between a power transmitter and a power receiver. A device includes a transceiver that is used for such wireless power communications in addition to being used for other wireless communications with other devices. An initial low power process may be provided by the wireless charging system that triggers communication session establishment to be able to exchange power transfer parameters and initiate power transfer to provide power to the device. Particularly, in dead or low power battery situations, a device that receives wirelessly power may need to quickly advertise its presence to a power transmitter to establish a communication session (i.e., the device needs to advertise presence within some pre-determined amount of time after absorbing a lower power beacon from a transmitter operating in standby mode).

Aspects of exemplary implementations described herein are directed to an architecture for handling issues related to powering on a device and the transceiver in response to wirelessly receiving power and allowing for immediate or rapid advertisement communication to the transmitter while also leveraging re-use or sharing of resources for controlling the transceiver. For example, in an aspects, exemplary implementations may define a “fast” boot or initialization sequence procedure of the transceiver that allows for rapid advertisement transmissions to a power transmitter while also later allowing efficient general control of the transceiver by a central controller or processor after power is stable and other components have finished initialization sequences. In an aspect, potentially overlapping communication software stacks are defined in different controllers (e.g., in a transceiver firmware and a main application processor) for controlling wireless power communications. These communication software stacks are leveraged to execute the “fast” boot procedure while using a single transceiver for wireless power communications and other generic communications to other devices as will be further described below.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

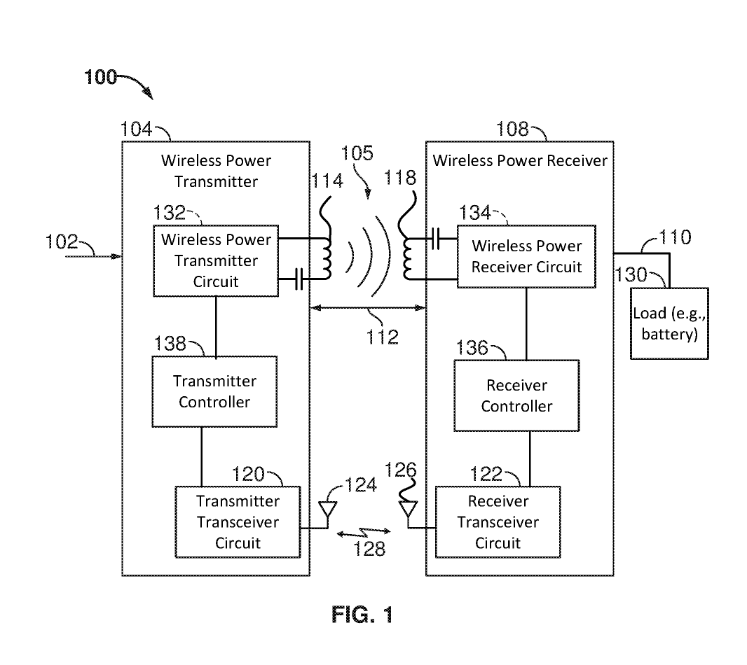

FIG. 1 is a functional block diagram of an example implementation of a wireless power transfer system 100. Input power 102 is provided to a wireless power transmitter 104 from a power source (not shown in this figure) to generate a wireless (e.g., magnetic or electromagnetic) field 105 for performing energy transfer. A wireless power receiver 108 couples to the wireless field 105 and generates output power 110 for storing or consumption by a load 130 (e.g., battery) coupled to the output power 110. The wireless power transmitter 104 and the wireless power receiver 108 may be separated by a distance 112. The wireless power transmitter 104 includes a power transmitting element 114 for transmitting/coupling energy to the wireless power receiver 108. The wireless power receiver 108 includes a power receiving element 118 for receiving or capturing/coupling energy transmitted from the wireless power transmitter 104.

In one exemplary implementation, the wireless power transmitter 104 and the wireless power receiver 108 may be configured according to a mutual resonant relationship. For example, as shown in the example system in FIG. 1, the wireless power transmitting element 114 and the wireless power receiver element 118 may both be LC resonant circuits both substantially resonant at a common resonant frequency and may inductively couple power via a magnetic field 105 generated by the wireless power transmitting element 114. When the resonant frequency of the wireless power receiver 108 and the resonant frequency of the wireless power transmitter 104 are substantially the same or very close, transmission losses between the wireless power transmitter 104 and the wireless power receiver 108 are reduced. As such, wireless power transfer may be provided over larger distances. Resonant inductive coupling techniques may allow for improved efficiency and power transfer over various distances and with a variety of inductive power transmitting and receiving element configurations.

In certain implementations, the wireless field 105 may correspond to the “near field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114.

In certain implementations, efficient energy transfer may occur by coupling a large portion of the energy in the wireless field 105 to the power receiving element 118 rather than propagating most of the energy in an electromagnetic wave to the far field.

In one example operation, the wireless power transmitter 104 outputs a time varying magnetic (or electromagnetic) field with a frequency corresponding to the resonant frequency of the power transmitting element 114. When the receiver 108 is within the wireless field 105, the time varying magnetic (or electromagnetic) field induces a voltage in the power receiving element 118. An alternating current (AC) signal generated based on the voltage in the power receiving element 118 may be rectified to produce a direct current (DC) signal that may be provided to charge or to power the load 130.

The wireless power transmitter 104 includes a wireless power transmit circuit 132 that is operably connected to the power transmitting element 114. The wireless power transmit circuit 132 is configured to receive power from the input power 102 and convert it in a way to drive the power transmitting element 114 such that the power transmitting element can generate a field 105 for wirelessly transferring power. As an example, the wireless power transmit circuit 132 may include circuitry such as inverters, amplifiers (e.g., class-E amplifier), power factor correction circuitry, oscillators, tuning circuitry, filter circuitry, impedance matching circuit and the like (and any combination thereof). For example, the wireless power transmitter circuit 132 may be configured to drive the power transmitting element 114 at, for example, a resonant frequency of the power transmitting element 114, based on an input voltage signal.

The wireless power transmitter circuit 132 may include a filter circuit (not shown) configured to filter out harmonics or other unwanted frequencies and (or combined with) a matching circuit configured to match the impedance of the wireless power transmitter circuit 132 to the impedance of the power transmitting element 114. In addition to or in combination with the matching/filter circuit, the wireless power transmitter circuit 132 may include a tuning circuit to create a resonant circuit with the power transmitting element 114.

The wireless power transmitter 104 further includes a transmitter controller 138 operably connected to the wireless power transmitter circuit 132 and configured to control one or more aspects of the wireless power transmitter circuit 132, or accomplish other operations relevant to managing the transfer of power. The transmitter controller 138 may be a micro-controller or a processor. The transmitter controller 138 may be implemented as an application-specific integrated circuit (ASIC). The transmitter controller 138 may be operably connected, directly or indirectly, to each component of the wireless power transmitter circuit 132. The transmitter controller 138 may be further configured to receive information from each of the components of the wireless power transmitter circuit 132 and perform calculations based on the received information. The transmitter controller 138 may be configured to generate control signals for each of the components that may adjust the operation of that component. As such, the transmitter controller 138 may be configured to adjust or manage the power transfer based on a result of the operations performed by it. The wireless power transmitter 104 may further include a memory (not shown) configured to store data, for example, such as instructions for causing the transmitter controller 138 to perform particular functions, such as those related to management of wireless power transfer.

The wireless power receiver 108 includes a wireless power receiver circuit 134 that is operably connected to the power receiving element 118. The wireless power receiver circuit 134 includes circuitry configured to convert and or condition the power received wirelessly at the power receive element 118 suitable for delivery to the load (e.g., battery or other electronics). As an example, the wireless power receiver circuit 134 may include components such as filter circuits, matching circuits, rectifiers, buck converters, charge pumps, and the like (or any combination thereof). Matching circuitry may be configured to match the impedance of the wireless power receiver circuit 134 to the impedance of the power receiving element 118. Similar to the wireless power transmitter circuit 132, the wireless power receiver circuit 134 may include a tuning circuit (not shown) to create a resonant circuit with the power receiving element 118.

The wireless power receiver 108 further includes a receiver controller 136 operably connected to the wireless power receiver circuit 134 and configured similarly to the transmitter controller 138 as described above for managing one or more aspects of the wireless power receiver 108. The wireless power receiver 108 may further include a memory (not shown) configured to store data, for example, such as instructions for causing the receiver controller 136 to perform particular functions, such as those related to management of wireless power transfer.

The power transmitting element 114 or the power receiving element 118 may also be referred to or be configured as an antenna or a “loop” antenna. The term “antenna” generally refers to a component that may wirelessly output or receive energy for coupling to another antenna. The power transmitting element 114 or the power receiving element 118 may also be referred to herein or be configured as a “magnetic” antenna, or an induction coil, a resonator, or a portion of a resonator. The power transmitting element 114 or the power receiving element 118 may also be referred to as a coil or resonator of a type that is configured to wirelessly output or receive power. As used herein, power transmitting element 114 or the power receiving element 118 is an example of a “power transfer component” of a type that is configured to wirelessly output and/or receive power. The power transmitting element 114 or the power receiving element 118 may include an air core or a physical core such as a ferrite core (not shown in this figure).

In one example, when the power transmitting element 114 or the power receiving element 118 is configured as a resonant circuit or resonator with tuning circuit, the resonant frequency of the power transmitting element 114 or the power receiving element 118 may be based on the inductance and capacitance. Inductance may be simply the inductance created by a coil and/or other inductor forming the power transmitting element 114 or the power receiving element 118. Capacitance (e.g., a capacitor) may be provided by the tuning circuit to create a resonant structure at a desired resonant frequency. A capacitor may be electrically connected either in series or in parallel with the inductor (or some combination of capacitor in a combination of series and parallel with the inductor).

Although aspects disclosed herein may be applicable to resonant wireless power transfer, persons of ordinary skill will appreciate that aspects disclosed herein may be used in non-resonant implementations for wireless power transfer.

The wireless power transmitter 104 and the wireless power receiver 108 communicate on a separate wireless communication channel 128 (e.g., Bluetooth, Zigbee, WiFi cellular, etc.). The wireless power transmitter 104 includes an antenna 124 and a transmitter transceiver circuit 120 operably connected to the antenna 124 and configured to wirelessly receive or transmit data (e.g., messages) to the wireless power receiver 108. The transmitter controller 138 is operably connected to the transmitter transceiver circuit 120 to control one or more operations of the transmitter transceiver circuit 120 to cause the transmitter transceiver circuit 120 to wirelessly transmit one or more messages based on operation of the wireless power transmitter circuit 132. The wireless power receiver 108 also includes an antenna 126 and a receiver transceiver circuit 122 operably connected to the antenna 126 and configured to wirelessly receive or transmit data (e.g., messages) to the wireless power transmitter 104. The receiver controller 136 is operably connected to the receiver transceiver circuit 122 to control one or more operations of the receiver transceiver circuit 122 to cause the receiver transceiver circuit 122 to wirelessly transmit one or more messages based on the operations of the wireless power receiver circuit 134.

In many implementations, the wireless power receiver 108 is incorporated into a portable electronic device (e.g., handset (e.g., smartphone or other device), laptop, smart watch, wearable, and the like). The portable electronic device may have its own processors, communication circuitry, power management circuitry, and other ASICs and controllers for providing various applications and services.

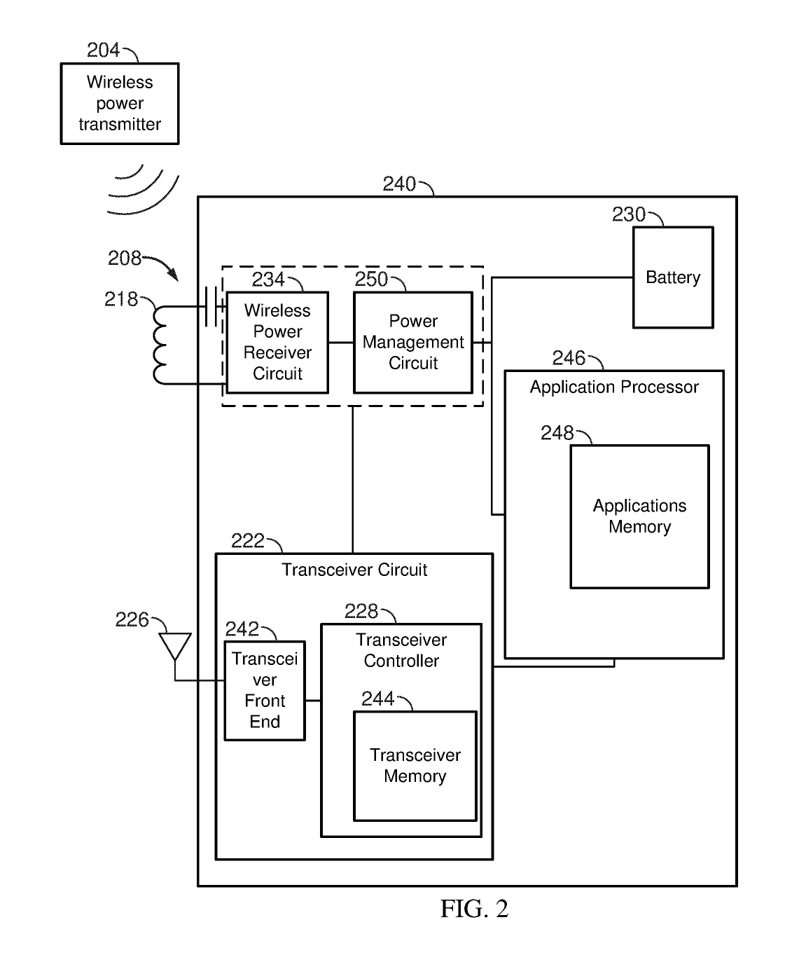

FIG. 2 is a functional block diagram of an example implementation of a device 240 incorporating a wireless power receiver 208 such as was described with respect to FIG. 1. As described with reference to FIG. 1, the device 240 includes a power receiving element 218, a wireless power receiver circuit 234, a battery 230, and a transceiver circuit 222 with antenna 226 (each configured, for example, as described with reference to FIG. 1). The power receiving element 218 is configured to wirelessly receive power from a wireless power transmitter 204 as described with reference to FIG. 1 to charge the battery 230 or power one or more of the components of the device 240.

In addition, the device 240 includes a power management circuit 250 (e.g., a power management integrated circuit (“PMIC”)). The power management circuit 250 is operatively connected to the wireless power receiver circuit 234 and is configured to receive power from the wireless power receiver circuit 234. The power management circuit 250 may be configured to perform at least a portion of the conversion and conditioning functionality described with reference to the wireless power receiver circuit 134 of FIG. 1. As certain functions or circuitry are shared or interchangeable (e.g., can be implemented in either block) between the wireless power receiver circuit 234 and the power management circuit 250, a dotted line is shown enclosing both. As such, hereafter it is understood that certain signals or output could be provided from either the wireless power receiver circuit 234 or the power management circuit 250 or a combination of both (and in some circumstances the combination could be referred to as the wireless power receiver circuit 234). In particular, the power management circuit 250 receives power from different power sources (e.g., wired as well as from the battery 230) including from the wireless power receiver circuit 234 and is configured to provide the power as needed to charge the battery 230 and also provide power from the battery for provision of power to various components of the device 240 (e.g., provide various levels of voltage output to various components, such as various power rails). In some cases the wireless power receiver circuit 234 can directly provide power to other components such as the transceiver circuit 222 or the power can go first through the power management circuit 250. The power management circuit 250 is further configured to provide various signals to the components of the device 240 such as clock signals and initialization signals to trigger initialization (e.g., boot) sequences.

The device further includes an application processor 246 that is configured to control one or more components of the device 240 including one or more components not shown such as a display, sensors, communication circuitry, and the like. The application processor 246 may be implemented as an application-specific integrated circuit (ASIC) and may be part of a system on chip (SoC) that may incorporate various functions not shown such as a DSP, GPU, WAN or LAN modems, and the like. One or more of the other components shown, such as the power management circuit 250, may be considered a part of the SoC as well. The application processor 246 includes an applications memory 248 that is configured to store one or more instructions for execution by the application processor 246. Together, the application processor 246 and the applications memory 248 may form an operating system or cause execution of an operating system to run various applications or control functions of the device 240. For example, the operating system might be the Android operating system and the software stack included as a part of the Android operating system may be stored in the applications memory 248.

As mentioned previously, the device 240 includes a transceiver circuit 222 and antenna 226 that are configured similar to the receiver transceiver circuit 122 of FIG. 1. The transceiver circuit 222 is operatively connected to the wireless power receiver circuit 234 and the power management circuit 250. The transceiver circuit 222 is configured to wireless transmit and receive data. The transceiver circuit 222 may be one of many transceiver circuits (and other antennas in addition to the antenna 226) of the device 240 implementing other communication protocols or having different characteristics (other transceiver circuits and antennas not shown). For example, the transceiver circuit 222 may implement a relatively shorter range communications protocol corresponding a personal area network (PAN) such as Bluetooth (and Bluetooth low energy) while other transceivers may implement other longer range communication protocols such as WLAN (e.g., WIFI), WAN (e.g., cellular), and the like. In some cases the transceiver circuit 222 may have functionality to partially implement multiple communication protocols (e.g., be configured at least partially to provide both Bluetooth and WiFi transceiver functionality or share parts of front end circuitry and/or the antenna 226).

With reference to FIG. 1, the receiver transceiver circuit 122 is described with reference for managing wireless communication to control power transfer. In addition, the transceiver circuit 222 of FIG. 2 may function as a more general purpose transceiver circuit 222 to not only mange wireless communication to control power transfer but also manage communications for other purposes based on control by the application processor 246. For example, if the transceiver circuit 222 corresponds to a Bluetooth transceiver that transmits and receives based on the Bluetooth or Bluetooth low energy protocols, then the application processor 246 may be configured to cause the transceiver circuit 222 to transmit (and handle receiving) of various messages for a variety of purposes such as for communicating with peripherals such as headsets, ear pieces, smart watches, keyboards, and the like. This may be in addition to managing communications for wireless power transfer.

The transceiver circuit 222 includes a transceiver controller 228 with a transceiver memory 244 (e.g., may be referred to as firmware). The transceiver memory 244 is configured to store one or more instructions executable by the transceiver controller 228 for carrying out communications based on a communication protocol. In addition, the transceiver memory 244 is configured to store a set of instructions defining a wireless power communication profile or service for managing a wireless power charging session between the wireless power receiver circuit 234 and the wireless power transmitter 204. In an aspect, a communication profile as used herein may refer to a predefined definition of messages for transmitting and receiving data based on a particular application. For example, a wireless power communication profile, in one aspect, may define a set of wireless power characteristics and related data formats for exchanging between the wireless power receiver 208 and the wireless power transmitter 204 useful for managing a charging session. For example, the wireless power communication profile may define message formats and an associated protocol for providing a received power/voltage level, over voltage indicators, battery status messages, and the like. The transceiver controller 228 is configured to execute the set of instructions to cause the transceiver circuit 222 to wirelessly transmit and receive data according to the wireless power communication profile. For example, if the transceiver circuit 222 is a Bluetooth transceiver, the transceiver memory 244 may store a portion of a Bluetooth software stack. The portion of the Bluetooth software stack includes a portion for implementing a wireless power communication profile for managing a wireless power charging session. The transceiver circuit 222 also includes a transceiver front end 242 operably connected to the transceiver controller 228 and the antenna 226 which may have one or more filters, amplifiers, and the like configured to enable transmitting and receiving data via the antenna 226.

As shown in FIG. 2, the application processor 246 is operably connected to the transceiver circuit 222 and the power management circuit 250. In addition, the power management circuit 250 is operably connected to the transceiver circuit 222, the wireless power receiver circuit 234, and the battery 230. Other operable connections not shown are also contemplated (e.g., between the transceiver circuit 222 and the wireless power receiver circuit 234, or between the application processor 246 and the wireless power receiver circuit 234, and the like). As such any other operable connections for providing any variety of signals between the components is contemplated by the implementations described herein.

In some cases, the battery 230 may be dead or sufficiently low such that device may be shut down or may not be able to operate all of its components (e.g., the application processor 246) until it receives a source of sufficient power. In addition, in order for the wireless power receiver 208 to establish a wireless power transfer session with the wireless power transmitter 204, a communication session may need to be established via the transceiver circuit 222 which may need a source of power to operate. To conserve power when no devices are present, the wireless power transmitter 204 may provide power on a periodic basis and at a relatively low level (e.g., lower than for normal power transfer or at some normal power level but for only 10% of a cycle). As just one example, according to the AirFuel magnetic resonance specification, the wireless power transmitter 204 is configured to provide a periodic power beacon. Other wireless power systems/protocols may define similar functionality and are contemplated by the embodiments herein. The power received at the wireless power receiver circuit 234 via the power beacons may be provided for both device detection/discovery and to provide sufficient power for a device 240 with a dead or low battery 230 to initially power various components. Particularly, the power received at the wireless power receiver circuit 234 may be used to power the components that allow for establishing a communication session between the transmitter transceiver circuit 120 (FIG. 1) of the wireless power transmitter 204 and the transceiver circuit 222 of the device 240. Once the communication session is established and any authentication and other handshaking operations (e.g., exchange of wireless power transfers parameters) are performed, the wireless power transmitter 204 increases the level of power transmitted and the device 240 via the power management circuit 250 may start to charge the battery and initialize/boot other components (e.g., boot the application processor 246).

In accordance with an implementation, in order to establish the communication session for wireless power transfer, the transceiver circuit 222 may transmit a certain message (e.g., an advertisement message) defined by the wireless power communication profile for establishing communication within a pre-determined time period from the detection of the power beacon. For example, if the transceiver circuit 222 implements a Bluetooth communication protocol, the transceiver circuit 222 sends one or more Bluetooth advertisement within a predefined time period (e.g., within 100 ms according to the AirFuel magnetic resonance specification) of the start of receiving a power beacon according to a wireless power communication profile that conforms to Bluetooth communication profiles. As a result, any components used for sending the advertisement message would need to be initialized (e.g., booted) within the pre-determined time period from when the power beacon is provided to be able to send the transmitter 204 the advertisement message. The predefined time period is defined to allow the wireless power transmitter 204 to conserve power by only listening for an advertisement message for a short period of time after detecting a device is absorbing power from the power beacons.

In some implementations, the set of instructions that implements the wireless power communication profile for managing communications for wireless power transfer (e.g., particular software stack defining the wireless power communication profile) may be stored within the applications memory 248 along with instructions for managing communications with other devices (e.g., other communication profiles). These communications are then managed/executed by the application processor 246. In this case, then, in order for the transceiver circuit 222 to transmit the advertisement message to the wireless power transmitter 204 to initiate establishment of a communication session, the application processor 246 needs to be powered and initialized. This process could take up to several seconds or at least be much longer than the time specified to transmit the advertisement message to the wireless power transmitter 204. In addition, the transceiver circuit 222 may normally only be initialized or activated to be operable to communicate after or at some period during the boot sequence of the application processor 246. Because the boot process may be too lengthy, the advertisement message cannot be transmitted timely to the wireless power transmitter 204 and it may be then difficult to successfully establish any communication session with the transmitter in order to initiate power transfer at sufficient levels for charging.

In one implementation, a separate and additional transceiver circuit (not shown) may be provided with the special purpose of managing the wireless power transfer session. The wireless power receiver circuit 234 may then provide power to the separate and additional transceiver circuit in response to the power beacon and the additional transceiver circuit transmits the advertisement message to initiate establishment of the communication session with the wireless power transmitter 204. However, this approach may increase costs and complexity and adds potentially duplicate components.

Certain implementations described herein are directed to being able to satisfy timing requirements for establishing communication sessions for wireless power transfer while using a single transceiver circuit 222. Or stated another way, directed to satisfying timing requirements for establishing wireless power communications while using a transceiver circuit 222 for all communications managed by the particular protocol the transceiver circuit 222 supports without adding an additional transceiver circuit 222.

As mentioned above, the applications memory 248 may include instructions (e.g., a communications software stack) defining a wireless power communication profile compatible according to operation of the wireless power receiver circuit 234 in addition to managing communications via the transceiver circuit 222 for communication with other devices. For example, if Bluetooth protocols/profiles are used for managing wireless charging sessions, the applications memory 248 may include instructions for communication profiles for generally communicating and pairing with a variety of peripheral and other devices while also including instructions to manage the wireless charging communications according to the wireless power communication profile. The application processor 246 is therefore configured to control the transceiver circuit 222 for management of various communications including for wireless power transfer.

In accordance with one implementation, and as mentioned above, the transceiver memory 244 includes a set of instructions (e.g., its own communication software stack in its firmware) that can be used independently of the application processor 246 to control and manage certain communications. When the transceiver controller 228 is managing communications based on the set of instructions from the transceiver memory 244, it may be referred to operation of the transceiver circuit 222 in an embedded mode. This is in comparison to managing communications via the application processor 246 that may be referred to operation of the transceiver circuit 222 in host mode. The set of instructions in the transceiver memory 244 may include instructions defining a wireless power communication profile for managing communications for the wireless charging session. As such both the applications memory 248 and the transceiver memory 244 may both include instructions (e.g., overlapping communication software stacks) for defining the same wireless power communication profile for managing communications for the wireless charging session. Therefore there is some amount of overlap in the functionality/instructions as executed by both the application processor 246 and the transceiver controller 228.

In some implementations, the set of instructions stored in the transceiver memory 244 may define a significantly reduced functionality or implement fewer communication profiles as compared to what is implemented defined in the application processor 246 (e.g., the transceiver may store instructions for the wireless power communication profile but not for certain other types of communication profiles for communicating with other devices). Stated another way, the set of instructions in the transceiver memory 244 defines a first set of instructions. The applications memory 248 defines a second set of instructions, different from the first set of instructions. The second set of instructions also defines at least a portion of the wireless power communication profile for managing the wireless power charging session between the wireless power receiver circuit 234 and the wireless power transmitter 204 via the transceiver circuit 222. The second set of instructions further defines other communication profiles for managing other communications to other devices via the transceiver circuit 222.

In accordance with this implementation, the initialization sequence (e.g., power on sequence or boot sequence) is modified/adapted to cause the transceiver circuit 222 to send an advertisement message to the wireless power transmitter 204 in response to a power beacon while also allowing later more general use of the transceiver circuit 222 for other communications functions for other devices.

More particularly, a power beacon is received via the power receiving element 218 when the device 240 is positioned within the charging region of the wireless power transmitter 204. In some cases, the wireless power receiver circuit 234 is configured to provide the received power to the power management circuit 250. The power management circuit 250 is configured to detect that the power is received from the wireless power receiver circuit 234. For example, the wireless power receiver circuit 234 is configured to convert power received to DC power and provide the DC power to the power management circuit 250. The power management circuit 250 is configured to detect that the DC input was the wireless power receiver circuit 234.

The wireless power receiver circuit 234 is configured to provide power to the transceiver circuit 222 along with a clock signal (e.g., provide one or more power rails and the clock signal). In some cases the power is provided by the wireless power receiver circuit 234 to the transceiver circuit 222 via the power management circuit 250 (e.g., the power management circuit 250 receives power and then provides the power to the transceiver circuit 222 or it could be some combination of the wireless power receiver circuit 234 and the power management circuit 250 that provides power and a clock signal). The wireless power receiver circuit 234 is also configured to provide a power source signal to the transceiver circuit 222 indicating that the wireless power receiver circuit 234 is the source of the power provided to the transceiver circuit 222. As noted above, in some implementations the power source signal is provided by the power management circuit 250 or combination of the power management circuit 250 and the power receiver circuit 234.

If the source of the power is the wireless power receiver circuit 234, the power management circuit 250 may wait to provide power (or other signals for triggering initialization sequences) to other components (e.g., the application processor 246).

The power and clock signal provided to the transceiver circuit 222 causes/triggers the transceiver controller to execute an initialization sequence. As an initial part of the initialization sequence, the transceiver controller 228 is configured to detect the power source signal indicating that the power received is from the wireless power receiver circuit 234.

The transceiver controller 228, in response to detecting the power source signal corresponds to wireless charging, is configured to execute an initialization sequence (e.g., a modified initialization sequence, “fast boot” or “fast power on sequence”). For example, it is modified or a “fast boot” as the initialization sequence may correspond to a first initialization sequence different from a second initialization sequence of the transceiver circuit when the source of power to the transceiver circuit 222 is different than from the wireless power receiver circuit 234.

The initialization sequence includes causing transmission of an advertisement message to the wireless power transmitter 204 according to the wireless power communication profile for establishing the wireless communication session with the wireless power transmitter 204. The transmission of the advertisement message is completed before initialization of one or more other functions defined by the wireless power communication profile. As such, in this initialization sequence, the transceiver controller 228 is configured to initialize and execute on only the components needed for transmitting the advertisement message (e.g., a Bluetooth advertisement message). This may involve initializing components and transmitting the advertisement message before initialization of the full instruction set/communication profile (e.g., full software stack) defined in the transceiver memory 244. The transceiver controller 228 is then configured to initialize one or more other functions defined by the wireless power communication profile after transmitting the advertisement message. For example, in regular operation the communication profile may make available, upon request, of several data parameters related to wireless power transfer as noted above. However, these data parameters for access by the wireless power transmitter 204 may not be loaded or otherwise made available/initialized until after a sub-set of resources are powered and the advertisement is transmitted. Note that in certain implementations the wireless power transmitter 204, in response to receiving the advertisement message may extend the power beacon. This may provide sufficient power to allow the transceiver circuit 222 enough time to initialize/activate the entire communication profile which may take much longer than length of the power beacon.

The advertisement message may therefore be transmitted within the pre-defined time period and without further delay. In one example, the transceiver circuit 222 is configured to send the advertisement message within 100 milliseconds of wirelessly receiving power at the wireless power receiver circuit 234. In an aspect, the transceiver controller 228 therefore executes in an embedded mode using its own instruction set stored in the transceiver memory 244 for initial operation when the source of power is via the wireless power receiver circuit 234. Further, the transceiver initialization sequence transmits the advertisement message for connection establishment with the wireless power transmitter 204 before initialization of the full instruction set/communication profile defined in the transceiver memory 244.

In response to the advertisement message, the wireless power transmitter 204 is configured to receive the advertisement message and further messages are exchanged as defined by the wireless power communication profile and a connection is established. Once the communication is established and the information from the wireless power receiver circuit 234 is validated/accepted by the wireless power transmitter 204 (e.g., per the wireless power communication profile) the wireless power transmitter 204 may send a command to enable wireless charging of device 240. Upon which instance, the power management circuit 250 is configured to provide power and signals/clocks to other components such as the application processor 246 to trigger initialization/book sequences. As such, the wirelessly received power is at a first level based on the power beacon. In response to the transceiver circuit 222 establishing a communication session with the wireless power transmitter 204 and receiving power at a second, higher, level, the power management circuit 250 is configured to provide power to the application processor 246 along with an application processor initialization signal to the application processor 246.

As mentioned above, the set of instructions stored in the transceiver memory 244 may define a first software stack (e.g., set of instructions for implementing a protocol) configured to control communications via the transceiver circuit 222. The set of instructions stored in the applications memory 248 defines a second software stack configured to control communications via the transceiver circuit 222. There may be overlap in the communication profiles implemented by each of the first and second software stacks.

In one aspect, as part of the initialization sequence of the application processor 246, the transceiver circuit 222 is configured to perform a handover of control of the transceiver circuit 222 from the first software stack to the second software stack. Because the transceiver memory 244 may not define all the communication profiles desired by the device 240 (and all other devices that the application processor 246 may connect to), the handover allows the application processor 246 to control all communications via the transceiver circuit 222. This includes having the application processor 246 handle communications for wireless power transfer according to the wireless power communication profile stored in the applications memory 248. This may reduce the amount of memory needed for the transceiver memory 244 which may save costs/size/complexity and may also avoid any coordination that would be needed between the transceiver controller 228 and the application processor 246 if both were managing various communications for different applications via the transceiver circuit 222.

In an aspect, each communication session between the wireless power transmitter 204 and the wireless power receiver 208 may be assigned a session identifier. As part of the handover, the application processor 246 causes a change of an identifier for a communications session that may be part of the communications protocol used via the transceiver circuit 222. The second software stack may change the session identifier. For example, if the Bluetooth protocol is implemented by the transceiver circuit 222 then the application processor 246 would cause change of the Bluetooth session identifier.

In another different implementation, both the transceiver controller 228 and the application processor 246 are configured to concurrently transmit or receive data and based on control by either the first software stack stored in the transceiver memory 244 and the second software stack stored in the applications memory 248. In this aspect, the transceiver controller 228 is configured to coordinate between the first software stack and the second software stack to transmit or receive data streams from either the first or second software stacks. For example, the transceiver controller 228 is configured to cause all communications defined by the second software stack stored in the applications memory 248 to be transmitted via the transceiver circuit 222 and handle any conflicts when communications are requested to be transmitted from both the first software stack and the second software stack. For example, the transceiver controller 228 may time multiplex communications that are provided by the application processor 246 and the transceiver controller 228.

Furthermore, upon receiving a message, the transceiver controller 228 is configured to determine whether the application processor 246 handles the message based on the communication profiles defined in the second software stack or whether the transceiver controller 228 handles the message based on the communication profiles defined in the first software stack. The transceiver controller 228 is configured to route any messages or other information to the application processor 246 based on the type of message. In one example, the transceiver controller 228 detects and analyzes packets for each message received. Based on the type of packet or other indicator detected in each packet, the transceiver controller 228 forwards the information to the application processor 246 or otherwise handles the message as defined in the communication profile stored in the first software stack.

This may allow maintaining just one instance of the communication profile, such as the wireless power communication profile, in the device 240 and provided by the transceiver memory 244. In addition, as the second software stack in the applications memory 248 may define multiple communication profiles, there may be periodic and often updates to the profiles. Re-integrating the wireless power communication profile into second software stack may therefore be needed for each and every update which could be complicated and/or time consuming for each update. As such, in accordance with this aspect, the re-integration may be avoided as the wireless power communication profile may be exclusively maintained in the first software stack in the transceiver memory 244.

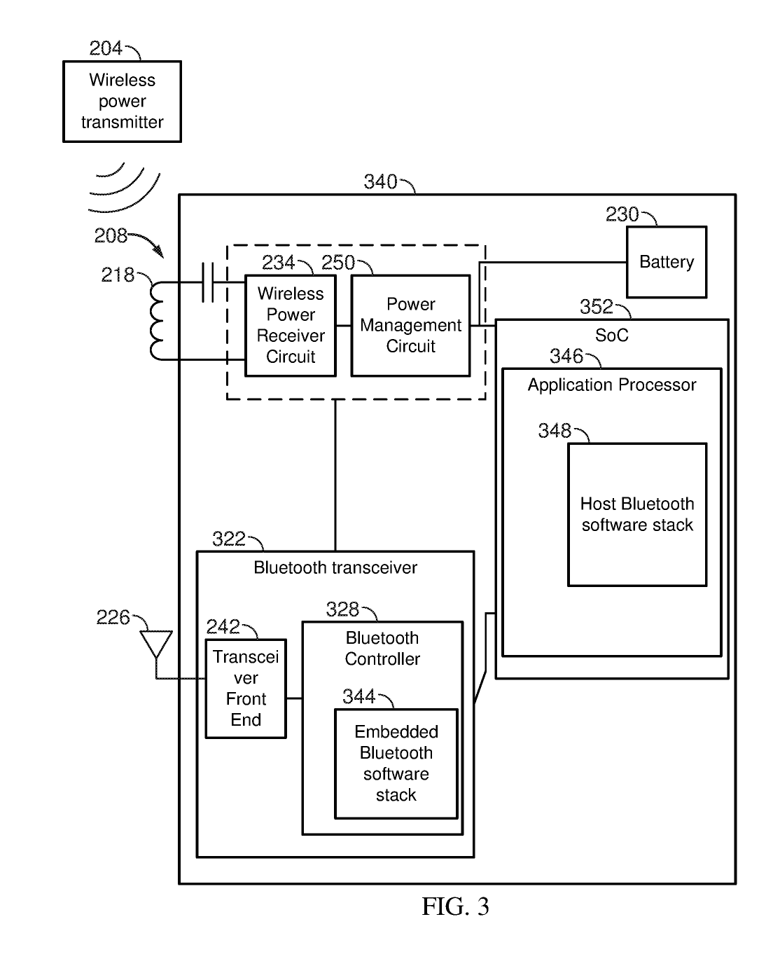

FIG. 3 is a functional block diagram of an exemplary more particular implementation of the device 240 of FIG. 2. In particular FIG. 3 shows a device 340 that uses a Bluetooth transceiver 322 (Bluetooth chip or Bluetooth transceiver circuit) that is configured to transmit and receive according to the Bluetooth protocol and associated communication profiles for management of the wireless power communications. Note that the components in FIG. 3 that are in common with FIG. 2 are noted with the same reference numbers and are described with reference to FIG. 2. For purposes of illustration, the device 340 further shows a system on chip 352 (SoC) which may be implemented in an integrated circuit (ASIC) or be a combination of interconnected components. The SoC 352 may implement a variety of functions and include a processor, modem, graphics processing unit, digital signal processor, memories, and the like. The SoC 352 includes an application processor 346 similar to the application processor 246 described with reference to FIG. 2. The application processor 346 includes a host Bluetooth software stack 348 that may be stored in memory. In an aspect, the host Bluetooth software stack 348 is a more particular example of the applications memory 248 of FIG. 2. The host Bluetooth software stack 348 comprises an instruction set corresponding to Bluetooth communication profiles that define the protocol and data characteristics for a particular communication application. For example, a Bluetooth wireless power communication profile may be provided by the host Bluetooth software stack 348. In addition, a profile for managing communications between the device 340 and a Bluetooth headset or speaker may also be provided by the host Bluetooth software stack 348. As such the host Bluetooth software stack 348 may define a variety of different communication profiles in addition to instruction set to allow the application processor 346 to wirelessly transmit and receive data based on a corresponding communication profile. For example, the host Bluetooth software stack 348 may be configured to define Bluetooth GATT profiles. The GATT profiles may include attribute tables for exposing characteristics for exchanging via the Bluetooth transceiver 322 (where tables may include storing information related to attribute type, UUID, attribute handle, permissions, values, and the like).

As mentioned, the device 340 includes a Bluetooth transceiver 322. The Bluetooth transceiver 322 may be implemented as an integrated circuit (e.g., ASIC). In one implementation, the Bluetooth transceiver 322 is a separate integrated circuit/component from the SoC 352 (however other implementations with various combinations and interconnects are also contemplated herein). In certain aspects, the Bluetooth transceiver 322 is an example of a more particular implementation of the transceiver circuit 222 of FIG. 2. The Bluetooth transceiver 322 is operably connected to the application processor 346 of the SoC and is configured to wirelessly transmit or receive information according to the Bluetooth protocol based on information/control signals by the application processor 346 (based on definition in the host Bluetooth software stack 348). The Bluetooth transceiver 322 includes a Bluetooth controller 328 and an embedded Bluetooth software stack 344. The Bluetooth controller 328 is an example of the transceiver controller 228 of FIG. 2. Furthermore, the embedded Bluetooth software stack 344 is an example of the transceiver memory 244 of FIG. 2. The terms “host” and “embedded” are used to differentiate between the two Bluetooth software stacks and differentiate between who may have control of communications via the Bluetooth transceiver 322. For example, the device 340 operates in an embedded mode where the Bluetooth controller 328 is configured to transmit and receive information and otherwise handle the input and output based on the embedded Bluetooth software stack 344. The device 340 operates in a host mode where the Bluetooth controller 328 is configured to transmit and receive information and otherwise handle the input and output based on the host Bluetooth software stack.

The embedded Bluetooth software stack 344 may also provide/define one or more communication profiles and instructions for allowing the Bluetooth controller 328 to wirelessly transmit information as defined by the embedded Bluetooth software stack 344. Furthermore, the Bluetooth controller 328 is configured to receive and receive data based on information/control signals from the host Bluetooth software stack 348. The Bluetooth transceiver 322 is configured to manage the wireless power communications based on a wireless power communication profile defined in either or both of the host Bluetooth software stack 348 and the embedded Bluetooth software stack 344.

In accordance with the device 340 of FIG. 3, similar to that described with reference to FIG. 2, the Bluetooth controller 328 has an embedded Bluetooth software stack that defines a wireless power communication profile for managing a wireless power charging session between the wireless power receiver circuit 234 and the wireless power transmitter 204. As an example, the wireless power communications profile may be defined by the AirFuel magnetic resonance baseline specification for managing communications for wireless charging via the wireless power receiver circuit 234 based on the AirFuel magnetic resonance baseline specification.

The Bluetooth controller 328 is configured to execute the set of instructions to cause the Bluetooth transceiver 322 to wirelessly transmit and receive data according to the wireless power communication profile.

In response to receiving power at the wireless power receiver circuit 234, power and a clock signal are provided to the Bluetooth transceiver 322. The power and clock signal may be provided by either the wireless power receiver circuit 234, the power management circuit 250 or a combination thereof (e.g., if functions are partially combined). Either the wireless power receiver circuit 234 or the power management circuit 250 (or combination thereof) is further configured to provide a power source signal to the Bluetooth transceiver 322 indicating that the wireless power receiver circuit 234 is the source of the power to the Bluetooth transceiver 322.

The Bluetooth controller 328 is configured to, in response to the power source signal, execute an initialization sequence that includes causing transmission of at least one Bluetooth advertisement message to the wireless power transmitter 204 according to the wireless power communication profile provided in the embedded Bluetooth software stack for establishing the wireless communication session with the wireless power transmitter before initialization of one or more other functions defined by the wireless power communication profile in the embedded Bluetooth software stack. In one implementation two, three or more advertisement messages are sent sequentially at different frequencies. For example, the initialization sequence may include activating a portion of the embedded Bluetooth software stack for transmission of the Bluetooth advertisement message, and initialization of the full embedded Bluetooth software stack after transmitting the Bluetooth advertisement message. More particularly, the wireless power communication profile may rely on a GATT/ATT profile to operate. The initialization of the wireless power communication profile and GATT/ATT profiles starts after the Bluetooth advertisement messages are sent. The advertisement triggers the wireless power transmitter 204 to extend its duration of the power beacon (e.g., as an example from 100 ms to 600 ms) for allowing the further time to complete this initialization of all profiles.

If the wireless power communication profile is defined according to the AirFuel magnetic resonance specification, the Bluetooth advertisement message is transmitted within 100 milliseconds of wirelessly receiving power at the wireless power receiver circuit 234.

Once a Bluetooth communication session is established with the wireless power transmitter 204, then wireless charging is permitted by the wireless power transmitter 204. When charging is authorized, the power management circuit 250 is configured to provide power to and an initialization signal to the application processor 346. As part of the initialization sequence of the application processor 346, the Bluetooth transceiver 322 may be configured to perform a handover of control of the Bluetooth transceiver 322 from the embedded Bluetooth software stack to the host Bluetooth software stack 348. In this way, the application processor 346, in an aspect, switches from an embedded control mode to a host control mode, such that the application processor 346, via the host Bluetooth software stack, provides communication services based on the wireless power communication profile along with any other communications for other Bluetooth communication profiles. As part of the process to switch to the host mode the Bluetooth session identifier may be changed in some implementations. Particularly, when in the embedded mode, the communication session established has a first session identifier. As part of the handover to the host mode, the session identifier is changed to a second session identifier.

In another exemplary implementation, the Bluetooth transceiver 322 is configured to transmit or receive data based on control from either the embedded Bluetooth software stack 344 or the host Bluetooth software stack 348. As such, the Bluetooth transceiver 322 is configured to coordinate between the embedded Bluetooth software stack 344 and the host Bluetooth software stack 348 via one or more hand-shaking operations to transmit data streams from either the embedded or host Bluetooth software stacks.

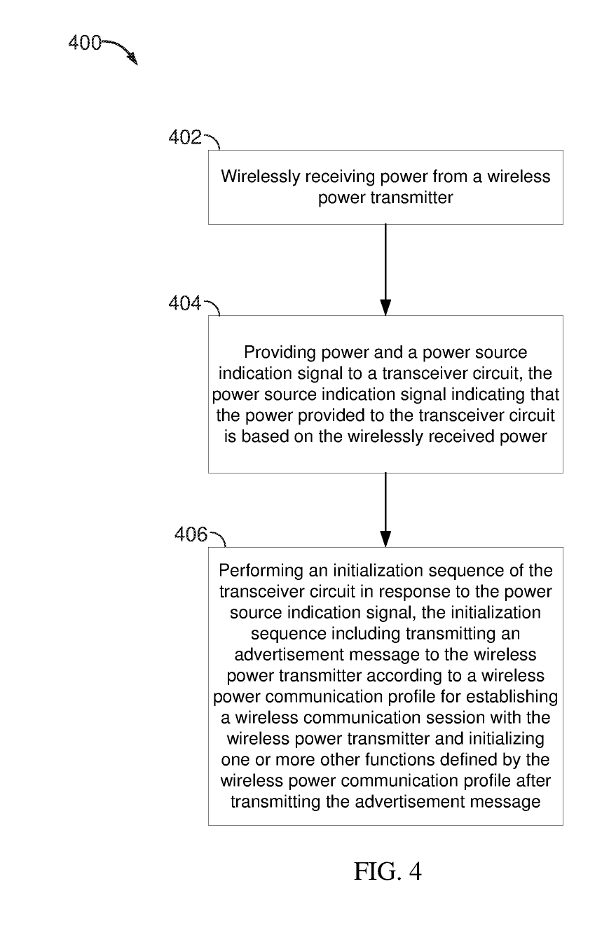

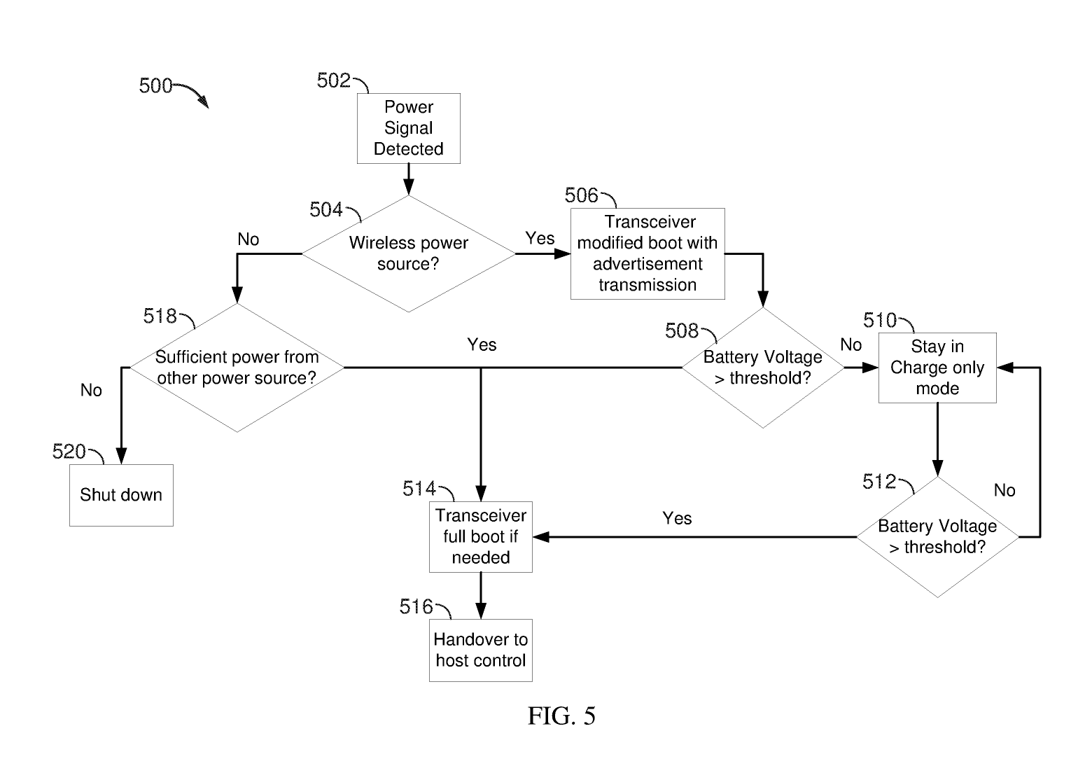

Turning now to a discussion of FIGS. 4 and 5, the following techniques of managing control of wireless power communications may be implemented using any of the previously described elements of the example environment, components, or circuits. Reference to elements, such as the transceiver circuit 222, wireless power receiver circuit 234, power management circuit 250, and application processor 246, is made by example only and is not intended to limit the ways in which the techniques can be implemented.

The techniques are described with reference to example methods illustrated in FIGS. 4 and 5 which are depicted as respective sets of operations or acts that may be performed by entities described herein. The operations described may be performed using any suitable circuitry or component, which may provide means for implementing one or more of the operations. The depicted sets of operations illustrate a few of the many ways in which the techniques may be implemented. As such, operations of a method may be repeated, combined, separated, omitted, performed in alternate orders, performed concurrently, or used in conjunction other methods illustrated in FIGS. 4 and 5 or operations thereof.

FIG. 4 is a flow diagram of a method 400 for controlling wireless power communications. The method 400 is described with reference to the elements of FIG. 2, however, as noted above, operations described may be performed using any suitable circuitry or component, which may provide means for implementing one or more of the operations.

As illustrated in operational block 402, the method 400 includes wirelessly receiving power from a wireless power transmitter 204. The power may be received at the wireless power receiver circuit 234 of FIG. 2. For example, the power may be received via inductive coupling in response to the power receiving element 218 of FIG. 4 being positioned in a charging region of the wireless power transmitter 204. In some implementations the power received is based on a power beacon provided by the wireless power transmitter 204 in a stand-by or low power mode.

The wireless power receiver circuit 234 may convert power inductively received into DC power that is provided at an input to the power management circuit 250. In some limitations, the power received may be lower than a power level that is sufficient to charge the battery sufficiently or power certain components of the device 240. In another implementation, power is received at a normal level during this period, but authorization may not be provided to start charging the battery based on the wirelessly received power.

As illustrated in operational block 404, the method 400 further includes providing power and a power source indication signal to a transceiver circuit 222. This signal may come from the wireless power receiver circuit 234 or combination of power management circuit 250 and wireless power receiver circuit 234. The power source indication signal indicates that the power provided to the transceiver circuit 222 is based on the wirelessly received power. In an aspect, the method further includes providing a clock signal to the transceiver circuit 222.

As illustrated in operational block 406, the method 400 further includes performing an initialization sequence of the transceiver circuit 222 in response to the power source indication signal. The initialization sequence includes transmitting an advertisement message to the wireless power transmitter 204 according to a wireless power communication profile for establishing the wireless communication session with the wireless power transmitter 204 and initializing one or more other functions defined by the wireless power communication profile after transmitting the advertisement message.

In one example, the wireless power communication profile conforms to a Bluetooth communication profile and where transmitting the advertisement includes executing a set of instructions defined by a Bluetooth software stack provided by the transceiver circuit 222. As such in this case, performing the initialization sequence includes activating a portion of the Bluetooth software stack for transmission of the advertisement message and initializing the full Bluetooth software stack defined by the set of instructions after transmitting the advertisement message. In this case the one or more other functions correspond to the full Bluetooth software stack.

Furthermore, in one implementation transmitting the advertisement includes transmitting the advertisement message within 100 milliseconds of wirelessly receiving power.

In one implementation, performing the initialization sequence may include executing a first set of instructions stored on a first memory (e.g., transceiver memory 244 of FIG. 2) associated with the transceiver circuit 222. In this case the first set of instructions implements the wireless power communication profile. In this case the method 400 may further include executing a second set of instructions stored on a second memory (e.g., applications memory 248 of FIG. 2), different from the first memory, and associated with an application processor 246, separate from the transceiver circuit 222. This second set of instructions also implements the wireless power communication protocol and in addition, the second set of instructions additionally implements other communication profiles for managing other communications to other devices via the transceiver circuit 222.

In one implementation, the first set of instructions stored in the transceiver memory 244 defines a first Bluetooth software stack configured to control communications via the transceiver circuit 222. And the second set of instructions mentioned above defines a second Bluetooth software stack defining control of communications via the transceiver circuit 222. The method 400, in this implementation, may further include performing a handover of control from the first Bluetooth software stack to the second Bluetooth software stack as part of an initialization sequence of the application processor 246. As part of the handover, the method 400 may further include changing a Bluetooth session identifier.

In some cases, rather than a handover, the method 400 may include transmitting or receiving communications concurrently as managed by either the first Bluetooth software stack or the second Bluetooth software stack. In this case the method 400 may further include coordinating transmission and reception of data via the transceiver circuit 222 between communications transmitted or received based on execution of the first set of instructions (first Bluetooth software stack) and communications transmitted or received based on execution of the second set of instructions (second Bluetooth software stack).

As mentioned above, wirelessly receiving power at operational block 402 may include wirelessly receiving power at a first level. In response to establishing a communication session with the wireless power transmitter 204, the method 400 may further include providing power to and an initialization signal to the application processor. This may be based on power received at a second, higher, level.

FIG. 5 is a flow diagram of a method 500 for responding to power from a wireless power source. This method 500 may be performed by a device (e.g., device 240 of FIG. 2) that may be initially receiving power when previously being powered off (e.g., dead battery or otherwise coming online from a powered off state). The method 500 is described with reference to the elements of FIG. 2, however, as noted above, operations described may be performed using any suitable circuitry or component, which may provide means for implementing one or more of the operations.

As illustrated at operational block 502, a power signal is detected. For example, the transceiver circuit 222 of FIG. 2 may detect incoming power at an input. At operational block 504 it is determined whether or not the source of the power is wireless power. For example, the transceiver circuit 222 may be configured to detect the power is received from the wireless power receiver circuit 234 or from some other source (e.g., wired).

If the source of the power is the wireless power source, then a modified transceiver boot process is executed that includes transmission of an advertisement message to the wireless power transmitter 204 as illustrated by operational block 506. For example, as described above, rather than fully initialize the set of instructions for the wireless power communication profile, the transceiver controller 228 brings up a reduced amount of resources/components (based on a power and clock signal provided by the wireless power receiver circuit 234 or power management circuit 250) to allow for transmission of the Bluetooth advertisement in sufficient time to meet any timing requirements for advertising to the wireless power transmitter 204 that the device would like to establish a communication session. The transceiver controller 228 then initializes other portions of the device for full functionality for management of the wireless power charging session.

At this point, it would be expected that a communication session would be established with the wireless power transmitter 204 and the wireless power transmitter 204 would be able to start transmitting at a higher level of power.

As such, as illustrated by operational block 508, it is determined whether the battery voltage is above a threshold. For example, the power management circuit 250 verifies that the battery voltage of the battery 230 is stable and sufficient for adequately powering other components of the device 240. If this battery is above a threshold then normal or other boot procedures can be triggered. For example, the power management circuit 250 may cause the transceiver circuit 222 to finish booting according to a “normal” boot process as illustrated in operational block 514. For example, any other operations or functions not initialized by the process in 506 may be initialized.

At this point, as described above, the transceiver controller 228 may be operating in an embedded mode and providing communications as defined by a software stack defined in the transceiver memory 244 that defines the wireless power communication profile. Therefore after or as part of the initialization process, the transceiver controller 228 transitions or does a handover from the embedded mode to a host mode as illustrated by operational block 516. In the host mode, the application processor 246 controls the communication via the transceiver circuit 222 via the software stack defined in the applications memory 248 including managing the wireless power communication profile.

As such, while there may be some redundancy of the implementation of the wireless power communication profile, the redundancy allows the device 240 to initialize quickly enough to transmit the advertisement but then later have a single generic controller or software stack to handle all communications via the transceiver circuit 222 (including those not related to wireless power but still sent via the transceiver circuit 222).

Going back to discussion of operational block 504, if the source of the power is not a wireless power source, then at operational block 518 it is determined whether the power from the other source is sufficient for powering the device 240. For example, the power management circuit 250 determines whether the voltage is provided by the input power is above a threshold for some period of time. If the power source is insufficient then a shut-down operation is performed and the device 240 waits for another source of power as shown by operational block 520. If the power from the source is sufficient as determined by the outcome of operational block 518, then full boot procedures for the device 240 are triggered. For example, as illustrated in operational block 514 a transceiver circuit 222 is initialized/booted according a defined initialization sequence that is not adjusted based on the source of power. This may be a different sequence that if the source is wireless power. For example either the wireless power communication profile is not initialized or at least the communication profiles are all initialized by without sending an advertisement message.

After or as part of the initialization process control of the transceiver circuit 222 is handed over to host control as illustrated in operational block 516. More particularly, as described above the software stack used for controlling communications via the transceiver circuit 222 is provided by the application processor 246 rather than via a software stack in the transceiver circuit 222.

Going back to discussion of operational block 508, if the battery voltage is not above the threshold the device 240 stays in a charge only mode as illustrated by operational block 510. In some situations, at this point there may be further initialization of the transceiver circuit 222 (e.g., after transmitting the advertisement to support more functionality for managing the wireless charging session while waiting for the battery to go above a threshold). For example, the power management circuit 250 may detect the battery voltage is not above a threshold and defer initialization (withhold power/clock signals) to other components such as to the application processor 246. Then the device can further charge until it has sufficient power to operate.

At operational block 512, the battery voltage is checked again to determine whether the battery voltage is above the threshold. If not, the transceiver circuit 222 stays in charge only mode. If the battery voltage is above a threshold, then the transceiver circuit 222 may be fully booted if needed as shown by operational block 514 and as described further above. For example, in some cases either the transceiver circuit 222 is booted as normal (without the advertisement) if the transceiver circuit 222 has not been booted previously. Or, if the transceiver circuit 222 went through a modified boot initialization sequence as shown in operational block 506, then at operational block 514, further functions may be initialized if needed to fully support other communications via the transceiver circuit 222.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for controlling wireless charging communications, the apparatus comprising:
a wireless power receiver circuit configured to wirelessly receive power from a wireless power transmitter; and
a transceiver circuit operatively connected to the wireless power receiver circuit, the transceiver circuit configured to wirelessly transmit and receive data, the transceiver circuit comprising a transceiver controller and a transceiver memory, the transceiver memory configured to store a set of instructions defining a wireless power communication profile for managing a wireless power charging session between the wireless power receiver circuit and the wireless power transmitter, the transceiver controller configured to execute the set of instructions to cause the transceiver circuit to wirelessly transmit and receive data according to the wireless power communication profile,
the wireless power receiver circuit configured to provide power to the transceiver circuit in response to receiving power, the wireless power receiver circuit further configured to, in response to receiving power, provide a power source signal to the transceiver circuit indicating that the power provided to the transceiver circuit is from the wireless power receiver circuit,
the transceiver controller configured to, in response to receiving the power source signal, execute an initialization sequence, wherein as at least a part of the initialization sequence the transceiver controller is configured to:
transmit an advertisement message to the wireless power transmitter according to the wireless power communication profile for establishing a wireless communication session with the wireless power transmitter; and
initialize one or more other functions defined by the wireless power communication profile after transmitting the advertisement message.

2. The apparatus of claim 1, wherein the initialization sequence corresponds to a first initialization sequence different from a second initialization sequence of the transceiver circuit used when the power provided to the transceiver circuit is not from the wireless power receiver circuit.

3. The apparatus of claim 1, wherein the transceiver circuit is configured as a Bluetooth transceiver circuit configured to wirelessly transmit or receive the data based on a Bluetooth communication protocol.

4. The apparatus of claim 3, wherein the set of instructions stored in the transceiver memory defines a Bluetooth software stack.

5. The apparatus of claim 4, wherein as part of the initialization sequence, the transceiver controller is configured to activate a portion of the Bluetooth software stack for transmission of the advertisement message and activate the full Bluetooth software stack defined by the set of instructions after transmitting the advertisement message.

6. The apparatus of claim 1, wherein the transceiver circuit is configured to send the advertisement message within 100 milliseconds of the wireless power receiver circuit wirelessly receiving power.

7. The apparatus of claim 1, wherein the set of instructions is a first set of instructions, wherein the apparatus further comprises an application processor, separate from the transceiver circuit, the application processor comprising an applications memory configured to store a second set of instructions, different from the first set of instructions, the second set of instructions also defining at least a portion of the wireless power communication profile for managing the wireless power charging session between the wireless power receiver circuit and the wireless power transmitter via the transceiver circuit, the second set of instructions further defining other communication profiles for managing other communications to other devices via the transceiver circuit.

8. The apparatus of claim 7, further comprising a power management circuit operably connected to an applications processor, wherein in response to the transceiver circuit establishing a communication session with the wireless power transmitter the power management circuit is configured to provide power to and an application processor initialization signal to the application processor.

9. The apparatus of claim 7, wherein the first set of instructions stored in the transceiver memory defines a first Bluetooth software stack configured to control communications via the transceiver circuit, and wherein the second set of instructions defines a second Bluetooth software stack defining control of communications via the transceiver circuit.

10. The apparatus of claim 9, wherein the transceiver circuit is configured to perform a handover of control of the transceiver circuit from the first Bluetooth software stack to the second Bluetooth software stack as part of an application processor initialization sequence.

11. The apparatus of claim 1, wherein the wireless power receiver circuit includes a power management circuit, wherein the power management circuit is configured to provide power to the transceiver circuit.

12. The apparatus of claim 1, wherein the set of instructions is a first set of instructions, wherein the apparatus further comprises an application processor, separate from the transceiver circuit, the application processor comprising an applications memory configured to store a second set of instructions, different from the first set of instructions, the second set of instructions defining one or more communication profiles different from the wireless power communication profile for managing wireless communications to other devices via the transceiver circuit.

13. The apparatus of claim 12, wherein the first set of instructions stored in the transceiver memory defines a first Bluetooth software stack configured to control communications via the transceiver circuit, and wherein the second set of instructions defines a second Bluetooth software stack configured to control communications via the transceiver circuit.

14. The apparatus of claim 13, wherein the transceiver circuit is configured to transmit or receive data based on control from either of the first Bluetooth software stack or the second Bluetooth software stack.

15. The apparatus of claim 14, wherein the transceiver controller is configured to coordinate transmitting and receiving data between the first Bluetooth software stack and the second Bluetooth software stack.

16. A method for managing wireless charging communications, the method comprising:
wirelessly receiving power from a wireless power transmitter;
providing power and a power source indication signal to a transceiver circuit, the power source indication signal indicating that the power provided to the transceiver circuit is based on the wirelessly received power; and
performing an initialization sequence of the transceiver circuit in response to the power source indication signal, the initialization sequence including:
transmitting an advertisement message to the wireless power transmitter according to a wireless power communication profile for establishing a wireless communication session with the wireless power transmitter; and
initializing one or more other functions defined by the wireless power communication profile after transmitting the advertisement message.

17. The method of claim 16, wherein the initialization sequence corresponds to a first initialization sequence different from a second initialization sequence of the transceiver circuit when the power provided to the transceiver circuit is not the wirelessly received power.

18. The method of claim 16, wherein the wireless power communication profile conforms to a Bluetooth communications profile, and wherein transmitting the advertisement message comprises executing a set of instructions defined by a Bluetooth software stack.

19. The method of claim 18, wherein performing the initialization sequence includes activating a portion of the Bluetooth software stack for transmission of the advertisement message, and initializing the full Bluetooth software stack defined by the set of instructions after transmitting the advertisement message, the one or more other functions corresponding to the full Bluetooth software stack.

20. The method of claim 16, wherein transmitting the advertisement message comprises transmitting the advertisement message within 100 milliseconds of wirelessly receiving power.

21. The method of claim 16, wherein performing the initialization sequence comprises executing a first set of instructions stored on a first memory associated with the transceiver circuit, the first set of instructions implementing the wireless power communication profile, wherein the method further comprises executing a second set of instructions stored on a second memory, different from the first memory, and associated with an application processor, separate from the transceiver circuit, the second set of instructions also implementing the wireless power communication profile, the second set of instructions additionally implementing other communication profiles for managing other communications to other devices via the transceiver circuit.

22. The method of claim 21, wherein wirelessly receiving power comprises wirelessly receiving power at a first level, and wherein in response to establishing a communication session with the wireless power transmitter and receiving power at a second, higher, level, the method further comprises providing power to and an application processor initialization signal to the application processor.

23. The method of claim 22, wherein the first set of instructions defines a first Bluetooth software stack configured to control communications via the transceiver circuit, and wherein the second set of instructions defines a second Bluetooth software stack defining control of communications via the transceiver circuit.

24. The method of claim 23, further comprising performing a handover of control from the first Bluetooth software stack to the second Bluetooth software stack as part of an application processor initialization sequence.

25. The method of claim 24, further comprising changing a Bluetooth session identifier as part of the handover of control.

26. The method of claim 21, wherein the method further comprises coordinating transmission and reception of data via the transceiver circuit between communications transmitted or received based on execution of the first set of instructions and communications transmitted or received based on execution of the second set of instructions.

27. An apparatus for controlling wireless charging communications, the apparatus comprising:
a transceiver circuit configured to wirelessly transmit and receive data, the transceiver circuit comprising a transceiver controller and a transceiver memory, the transceiver memory configured to store a set of instructions defining a wireless power communication profile for managing a wireless power charging session between a wireless power receiver circuit and a wireless power transmitter, the transceiver controller configured to execute the set of instructions to cause the transceiver circuit to wirelessly transmit and receive data according to the wireless power communication profile,
the transceiver controller configured to, in response to receiving power and a power source signal indicating that power provided to the transceiver circuit is from the wireless power receiver circuit, execute an initialization sequence that includes causing transmission of an advertisement message to the wireless power transmitter according to the wireless power communication profile for establishing a wireless communication session with the wireless power transmitter before initialization of one or more other functions defined by the wireless power communication profile.

28. The apparatus of claim 27, wherein the transceiver circuit comprises a Bluetooth transceiver circuit configured to wirelessly transmit the data based on the Bluetooth communication protocol, wherein the set of instructions stored in the transceiver memory defines a Bluetooth software stack.

29. The apparatus of claim 27, wherein the set of instructions is a first set of instructions, wherein the apparatus further comprises an application processor, separate from the transceiver circuit, the application processor comprising an applications memory configured to store a second set of instructions, different from the first set of instructions, the second set of instructions also defining at least a portion of the wireless power communication profile for managing the wireless power charging session between the wireless power receiver circuit and the wireless power transmitter via the transceiver circuit, the second set of instructions further defining other communication profiles for managing other communications to other devices via the transceiver circuit.

30. An apparatus for controlling wireless charging communications, the apparatus comprising:
means for wirelessly receiving power from a wireless power transmitter;
means for providing power and a power source indication signal to a transceiver circuit, the power source indication signal indicating that the power provided to the transceiver circuit is based on the wirelessly received power; and
means for performing an initialization sequence of the transceiver circuit in response to the power source indication signal, the initialization sequence including:
transmitting an advertisement message to the wireless power transmitter according to a wireless power communication profile for establishing a wireless communication session with the wireless power transmitter; and
initializing one or more other functions defined by the wireless power communication profile.
